(19) United States
(12) Patent Application Publication
(10) Pub. No.: US 2011/0183062 A1
(43) Pub. Date: Jul. 28, 2011

(54) RANGE OF SHELF STABLE BABY FOODS IN WHICH THE CONTENT OF UNDESIRABLE INGREDIENTS IS CONTROLLED BY STAGE

(76) Inventors: Silja Ursel, Konstanz (DE); Martinas Kuslys, Grosshoechstetten (CH)

(21) Appl. No.: 12/672,906

(22) PCT Filed: Sep. 5, 2008
(86) PCT No.: PCT/EP2008/007262

§ 371 Date: Jul. 13, 2010

(30) Foreign Application Priority Data
Sep. 7, 2007 (EP) 07017567.4

(51) Int. Cl. A23L 1/30; A23L 1/212; A23L 1/31; A23L 1/36

(52) U.S. Cl. 426/632; 426/615; 426/634; 426/641

(57) ABSTRACT

A range of shelf stable baby food products wherein the content of undesirable ingredients is controlled according to a stage of infant development. Methods for assessing the safety of a baby food product ingredient are also provided.

### BACKGROUND OF THE INVENTION

1. Field of the Invention

The present invention relates generally to shelf stable baby foods and particularly to shelf stable baby foods in which the content of undesirable ingredients is controlled by stage.

2. Description of Related Art

Infants and children are not simply miniature adults. They may respond differently to chemical exposure because they are in a state of growth and development, which may affect their susceptibility. It is generally assumed that differences in susceptibility are due to pharmacokinetic and pharmacodynamic components. Infants and children are often assumed to be more susceptible to toxic effects, but this is not always the case, as susceptibility depends on the toxins, their biological properties, and exposure situation.

Beyond differences in inherent sensitivity, one concern is that childhood is characterised by growth and development and that toxins may interfere with these processes (very fast cell growth and multiplication). As a result, toxic exposure may have more serious consequences for children than for adults, irrespective of sensitivity. Additionally, immature physiological functions of the developing organism may lack some repair abilities, thereby making infants and young children more vulnerable to toxins, at least up to 1 year of age.

Patterns of exposure in infants differ from that of adults. Nutritional needs and food intakes in infants are higher on a body weight basis, while their dietary patterns are also different with a less varied diet, both of which contribute to higher intake of potentially toxic compounds.

Selecting appropriate ingredients for infants and young children can be very challenging, because different information, based on different methodologies and age groups exists worldwide. There is, therefore, a need for novel products and methods for addressing which foods should be given to infants and young children during various stages of developments.

### SUMMARY OF THE INVENTION

It is, therefore, an object of the invention to provide a range of shelf stable baby food products in which the content of undesirable ingredients is controlled by stage.

It is another object of the invention to provide methods for assessing the safety of baby food product ingredients.

These and other objects are achieved by providing a range of shelf stable baby food products wherein the content of undesirable ingredients is controlled according to a stage of infant development, wherein, (i) baby food products for infants from about 4 to about 6 months of age (Stage 1) comprise one or more of vegetables, legumes, meat, fruits and aromatic herbs and spices; and (ii) baby food products for infants from about 6 to about 8 months of age (Stage 2), from about 8 to about 12 months of age (Stage 3) or from about 12 to about 36 months of age (Stage 4 or Stage Junior) comprise one or more of vegetables, legumes, meat, fish, eggs, fruits, aromatic herbs and spices and nuts. Methods for assessing the safety of a baby food product comprise (i) assessing the safety of intrinsic constituents in the ingredient; (ii) assessing the presence of anti-nutritional factors in the ingredient; (iii) assessing the potential of the ingredient to cause an allergic reaction; and (iv) combining the results from steps (i) to (iii) and assigning the ingredient to one or more safety categories.

Other and further objects, features, and advantages of the present invention will be readily apparent to those skilled in the art.

### DETAILED DESCRIPTION OF THE INVENTION

Definitions

The term “about” means plus or minus 20%, more preferably plus or minus 10%, even more preferably plus or minus 5%, most preferably plus or minus 2%.

The term “food product” means any food, feed, snack, food supplement, treat, meal substitute, or meal replacement, whether intended for a human or an animal.

The term “antinutritional factor” means any component of an ingredient that prevents uptake of nutrients. Examples of antinutritional factors include lectins (haemagglutinins), trypsin and chemotrypsin inhibitors.

The term “intrinsic constituent” means any factor which is intrinsically present in a food ingredient.

The term “undesirable ingredient” means any ingredient which might not be safe for consumption or which may provide a negative nutritional effect. Undesirable ingredients may include, among other things, antinutritional factors, toxins and allergens.

The term “shelf stable baby food product” means a baby food product that can be safely stored and sold in a sealed container at room temperature while still having a useful shelf life, for example at least about 2 months, preferably longer.

The invention is not limited to the particular methodology, protocols, and reagents described herein because they may vary. Further, the terminology used herein is for the purpose of describing particular embodiments only and is not intended to limit the scope of the present invention. As used herein and in the appended claims, the singular forms “a,” “an,” and “the” include plural reference unless the context clearly dictates otherwise.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the preferred methods, devices, and materials are described herein.

All patents, patent applications, and publications mentioned herein are incorporated herein by reference to the extent allowed by law for the purpose of describing and disclosing the compounds and methodologies reported therein that might be used with the present invention. However, nothing herein is to be construed as an admission that the invention is not entitled to antedate such disclosure by virtue of prior invention.

All percentages for weights expressed herein are by weight of the total food product unless specifically stated otherwise.

Within this specification embodiments have been described in a way which enables a clear and concise specification to be written, but it is intended and will be appreciated that embodiments may be variously combined or separated without parting from the invention

The Invention

In one aspect, the invention provides a range of shelf stable baby food products wherein the content of undesirable ingredients is controlled according to a stage of infant development, wherein, (i) baby food products for infants from about 4 to about 6 months of age (Stage 1) comprise one or more of vegetables, legumes, meat, fruits and aromatic herbs and spices; and (ii) baby food products for infants from about 6 to about 8 months of age (Stage 2), from about 8 to about 12 months of age (Stage 3) or from about 12 to about 36 months of age (Stage 4 or Stage Junior) comprise one or more of vegetables, legumes, meat, fish, eggs, fruits, aromatic herbs and spices and nuts.

Preferably, the range of products comprises at least one food product suitable for each stage of infant development.

Preferably, the range of products comprises two or more food products suitable for each stage of infant development. More preferably, the range of products comprises at least a vegetable based product and a fruit based product for each stage of infant development. More preferably, the range of products comprises a plurality of vegetable based products and fruit based products for each stage of infant development.

Preferably, the range of products comprises at least two food products suitable for at least two stages of infant development, more preferably at least three food products suitable for at least three stages of infant development, further preferably at least four food products suitable for at least four stages of infant development.

Preferably, the range of products comprises at least a vegetable based product and a fruit based product for stage 1 of infant development.

Preferably, the range of products comprises at least a vegetable based product, a complete meal and a fruit based product for stage 2 of infant development.

Preferably, the range of products comprises at least a vegetable based product, a complete meal and a fruit based product for stage 3 of infant development.

Preferably, the range of products comprises at least a vegetable based product, a complete meal and a fruit based product for stage 4 of infant development.

Preferably, baby food products for infants from about 4 to about 6 months of age (Stage 1) comprise one or more vegetables selected from artichoke, carrot, cucumber, fennel, French bean, leek, lettuce, parsnip, potato, pumpkin, squash and zucchini.

Preferably, baby food products for infants from about 4 to about 6 months of age (Stage 1) comprise the legume soy.

Preferably, baby food products for infants from about 4 to about 6 months of age (Stage 1) comprise one or more meats selected from beef, veal, chicken, lamb, pork, turkey and duck.

Preferably, baby food products for infants from about 4 to about 6 months of age (Stage 1) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant and watermelon.

Preferably, baby food products for infants from about 4 to about 6 months of age (Stage 1) comprise one or more aromatic herbs and spices selected from anise, balm mint, chamomile, caraway, gherkin, orange blossom and sorrel.

Preferably, baby food products for infants from about 6 to about 8 months of age (Stage 2) comprise one or more vegetables selected from artichoke, carrot, cucumber, fennel, French bean, leek, lettuce, parsnip, potato, pumpkin, squash, zucchini, broccoli, cauliflower, eggplant (aubergine), sweet potato, tomato, pea and spinach.

Preferably, baby food products for infants from about 6 to about 8 months of age (Stage 2) comprise one or more legumes selected from soy, black gram seed, chickpea, cowpea, kidney bean, lentil, mung bean and pigeon pea.

In another embodiment, baby food products for infants from about 6 to about 8 months of age (Stage 2) comprise one or more meats selected from of beef, veal, chicken, lamb, pork, turkey and duck, and/or fish.

Preferably, baby food products for infants from about 6 to about 8 months of age (Stage 2) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant, watermelon, fig, papaya, passionfruit, strawberry and tangerine.

Preferably, baby food products for infants from about 6 to about 8 months of age (Stage 2) comprise one or more aromatic herbs and spices selected from anise, balm mint, chamomile, caraway, gherkin, orange blossom, sorrel, cardamom, chives, cumin, onion, saffron, savory, shallot and thyme.

Preferably, baby food products for infants from about 6 to about 8 months of age (Stage 2) comprise coconut.

Preferably, baby food products for infants from about 8 to about 12 months of age (Stage 3) comprise one or more vegetables selected from artichoke, carrot, cucumber, fennel, French bean, leek, lettuce, parsnip, potato, pumpkin, squash, zucchini, broccoli, cauliflower, eggplant (aubergine), sweet potato, tomato, pea, spinach, asparagus, beet(root), brussel sprout, cabbage, garden pea, radish and turnip.

Preferably, baby food products for infants from about 8 to about 12 months of age (Stage 3) comprise one or more legumes selected from soy, black gram seed, chickpea, cowpea, kidney bean, lentil, mung bean, pigeon pea, lima bean and winged bean.

Preferably, baby food products for infants from about 8 to about 12 months of age (Stage 3) comprise one or more meats selected from beef, veal, chicken, lamb, pork, turkey and duck, and/or fish and/or eggs.

Preferably, baby food products for infants from about 8 to about 12 months of age (Stage 3) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant, watermelon, fig, papaya, passionfruit, strawberry, tangerine and rhubarb.

Preferably, baby food products for infants from about 8 to about 12 months of age (Stage 3) comprise one or more aromatic herbs and spices selected from anise, balm mint, chamomile, caraway, gherkin, orange blossom, sorrel, cardamom, chives, cumin, onion, saffron, savory, shallot, thyme, coriander, curcuma, garden sorrel, garlic, mint and vanilla.

Preferably, baby food products for infants from about 8 to about 12 months of age (Stage 3) comprise coconut and/or cocoa.

Preferably, it is preferred that baby food products for infants from about 12 to about 36 months of age (Stage Junior) comprise one or more vegetables selected from artichoke, carrot, cucumber, fennel, French bean, leek, lettuce, parsnip, potato, pumpkin, squash, zucchini, broccoli, cauliflower, eggplant (aubergine), sweet potato, tomato, pea, spinach, asparagus, beet(root), brussel sprout, cabbage, garden pea, radish, turnip, mushroom and watercress.

Preferably, baby food products for infants from about 12 to about 36 months of age (Stage Junior) comprise one or more legumes selected from soy, black gram seed, chickpea, cowpea, kidney bean, lentil, mung bean, pigeon pea, lima bean and winged bean.

Preferably, baby food products for infants from about 12 to about 36 months of age (Stage Junior) comprise one or more meats selected from beef, veal, chicken, lamb, pork, turkey, duck, and/or fish, and/or eggs and/or crustaceans.

Preferably, baby food products for infants from about 12 to about 36 months of age (Stage Junior) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant, watermelon, fig, papaya, passionfruit, strawberry, tangerine, rhubarb, grapefruit and kiwi.

Preferably, baby food products for infants from about 12 to about 36 months of age (Stage Junior) comprise one or more aromatic herbs and spices selected from anise, balm mint, chamomile, caraway, gherkin, orange blossom, sorrel, cardamom, chives, cumin, onion, saffron, savory, shallot, thyme, coriander, curcuma, garden sorrel, garlic, mint, vanilla, basil, bay laurel, chervil, cinnamon, clove, ginger, liquorice, mace, marjoram, nutmeg, oregano, parsley, pepper, rosemary, sage and terragon.

Preferably, baby food products for infants from about 12 to about 36 months of age (Stage Junior) comprise one or more nuts selected from coconut, cocoa, almond, beechnut, brazil nut, cashew nut, chestnut, hazelnut, macadamia nut, pecan nut, pistachio nut and walnut.

In another embodiment, the baby food products do not contain peanuts, sesame seeds, mustard or celery.

In another aspect, the invention provides a range of shelf stable baby food products comprising at least three sub-ranges each designed for a specific stage of infant development wherein the content of undesirable ingredients in each sub-range is controlled having regard to the stage of development for which it is intended.

Preferably, the sub-ranges are designed for a specific stage of infant development selected from (i) from about 4 to about 6 months of age (Stage 1); (ii) from about 6 to about 8 months of age (Stage 2); (iii) from about 8 to about 12 months of age (Stage 3); and (iv) from about 12 to about 36 months of age (Stage 4 or Stage Junior).

Preferably, the sub-ranges are designed for Stage 1, Stage 2 and Stage 3, more preferably for Stage 1, Stage 2, Stage 3 and Stage Junior.

In another aspect, the invention provides a method for assessing the safety of a baby food product ingredient, the method comprising:
(i) assessing the safety of intrinsic constituents in the ingredient;
(ii) assessing the presence of anti-nutritional factors in the ingredient;
(iii) assessing the potential of the ingredient to cause an allergic reaction; and
(iv) combining the results from steps (i) to (iii) and assigning the ingredient to one or more safety categories.

Preferably, the safety categories are selected from Group 1, Group 2, Group 3 and Group Junior, wherein
(a) ingredients assigned to Group 1 are safe for inclusion in a baby food product for infants from about 4 to about 6 months of age;
(b) ingredients assigned to Group 2 are safe for inclusion in a baby food product for infants from about 6 to about 8 months of age;
(c) ingredients assigned to Group 3 are safe for inclusion in a baby food product for infants from about 8 to about 12 months of age; and
(d) ingredients assigned to Group Junior are safe for inclusion in a baby food product for infants from about 12 to about 36 months of age.

In one embodiment, the safety categories are selected from 1A, 1B, 2A, 2B and 2C, wherein,
(a) ingredients assigned to 1A have a safe history of use in a particular infant population, raise no safety concern and require no specific precautions;
(b) ingredients assigned to 1B have a safe history of use in a particular infant population but are associated with particular precautions in sourcing, handling, processing or use levels;
(c) ingredients assigned to 2A have no evidence of adverse effects, no constituent of particular toxicological concern and require no particular precautions;
(d) ingredients assigned to 2B have evidence of adverse effects and/or constituents of particular toxicological concern but safety can be ensured by,
   (i) taking particular precautions in sourcing, handling, processing or use levels;
   (ii) keeping exposure levels below established health-based guidance values; or
   (iii) complying with maximum limits; and
(e) ingredients assigned to 2C have evidence of adverse effects and/or constituents of particular toxicological concern and safe levels cannot be established by,
   (i) taking particular precautions in sourcing, handling, processing or use levels;
   (ii) keeping exposure levels below established health-based guidance values; or
   (iii) complying with maximum limits

Preferably, ingredients assigned to 1A, 1B, 2A and 2B are safe for inclusion in a baby food product for infants from about 4 months of age, and ingredients assigned to 2C are safe for inclusion in a baby food product for infants from about 12 months of age.

Preferably, ingredients assigned to 2C are safe for inclusion in a baby food product for infants from about 12 months of age when present at use levels about 4 to about 5 times lower than use levels in adult food products.

### EXAMPLES

This invention can be further illustrated by the following examples although it will be understood that these examples are included merely for purposes of illustration and are not intended to limit the scope of the invention unless otherwise specifically indicated.

### Example 1

The chemical safety and suitable age of introduction of a number of food ingredients for use in infant foods was performed. The infant foods included a variety of products such as infant meals and drinks and milk-based products intended for infants from 4 to 6 months to 3 years of age.

Although local preferences exist, all food ingredients under review were consumed in substantial amounts in different parts of the world. When a food was not traditionally consumed in certain countries, regulatory approval and/or specific safety data were required. This review addressed the intrinsic safety of whole ingredients, the presence of anti-nutritional factors and the potential to cause an allergic reaction. It did not cover extracts, except water extracts used in infant teas, isolated compounds and chemical fractions, or foods on which treatments other than conventional processing had been applied.

Sourcing procedures for infant foods are of major importance. The selection of good suppliers and high quality raw materials helps control contaminants and some inherent toxicants.

Based upon the intrinsic safety of whole ingredients, the presence of anti-nutritional factors and the potential to cause an allergic reaction, the list of food ingredients was assessed and ingredients were identified which were safe for inclusion in baby food products at a number of stages of infant development. These stages of infant development were from about 4 to about 6 months of age (Stage 1), from about 6 to about 8 months of age (Stage 2), from about 8 to about 12 months of age (Stage 3) and from about 12 to about 36 months of age (Stage Junior).

TABLE 1
Ingredients which are safe to include in baby food products for infants
from about 4 to about 6 months of age (Stage 1), from about 6 to
about 8 months of age (Stage 2), from about 8 to about 12 months of
age (Stage 3) and from about 12 to about 36 months of age (Stage Junior).

| | |
|---|---|
| Vegetables | artichoke, carrot, cucumber, fennel, French |
| | bean, leek, lettuce, parsnip, potato, pumpkin, |
| | squash, zucchini |
| Legumes | soy |
| Meat/Fish/Egg | beef, veal, chicken, lamb, pork, turkey, duck |
| Fruits | apple, apricot, banana, blackberry, |
| | blackcurrant, bilberry, cherry, date, grape, |
| | gooseberry, guava, lemon, lime, mandarin, |
| | mango, melon, nectarine, olive, orange, |
| | peach, pear, pineapple, plum, quince, |
| | raspberry, redcurrant, watermelon |
| Aromatic herbs & spices | anise, balm mint, chamomile, caraway, |
| | gherkin, orange blossom, sorrel |

TABLE 2
Ingredients which are safe to include in baby food products for infants
from about 6 to about 8 months of age (Stage 2), from about 8
to about 12 months of age (Stage 3) and from about 12 to
about 36 months of age (Stage Junior).

| | |
|---|---|
| Vegetables | broccoli, cauliflower, eggplant (aubergine), |
| | sweet potato, tomato, pea, spinach |
| Legumes | black gram seed, chickpea, cowpea, kidney |
| | bean, lentil, mung bean, pigeon pea |
| Meat/Fish/Egg | fish |
| Fruits | fig, papaya, passionfruit, strawberry, |
| | tangerine |
| Aromatic herbs & spices | cardamom, chives, cumin, onion, saffron, |
| | savory, shallot, thyme |
| Nuts | coconut |

TABLE 3
Ingredients which are safe to include in baby food products for infants
from about 8 to about 12 months of age (Stage 3) and from about
12 to about 36 months of age (Stage Junior).

| | |
|---|---|
| Vegetables | asparagus, beet(root), brussel sprout, |
| | cabbage, garden pea, radish, turnip |
| Legumes | lima bean, winged bean |
| Meat/Fish/Egg | egg, fish |
| Fruits | rhubarb, watermelon |
| Aromatic herbs & spices | coriander, curcuma, garden sorrel, garlic, |
| | mint, vanilla |
| Nuts | cocoa |

TABLE 4
Ingredients which are safe to include in baby food products for infants
from about 12 to about 36 months of age (Stage Junior).

| | |
|---|---|
| Vegetables | mushroom, watercress |
| Meat/Fish/Egg | crustaceans |
| Fruits | grapefruit, kiwi |
| Aromatic herbs & spices | basil, bay laurel, chervil, cinnamon, clove, |
| | ginger, liquorice, mace, marjoram, nutmeg, |
| | oregano, parsley, pepper, rosemary, sage, |
| | terragon |
| Nuts | almond, beechnut, brazil nut, cashew nut, |
| | chestnut, hazelnut, macadamia nut, pecan |
| | nut, pistachio nut, walnut |

Detailed evaluation of the safety and anti-nutritional factors associated with ingredients typically used in baby foods allowed the correct selection of ingredients by stage. Where information was scarce a conservative approach to their introduction was taken.

### Example 2

The chemical safety and suitable age of introduction of a number of food ingredients for use in infant foods was performed. The infant foods included a variety of products such as infant meals and drinks and milk-based products intended for infants from 4 to 6 months to 3 years of age.

To assess the safety of all food ingredients under review for use in infant foods, a generic, transparent approach was established based on two criteria: (i) availability of a history of use in infants, and (ii) evidence of adverse effects and/or presence of constituents of particular toxicological concern. All food ingredients were systematically classified in 5 classes, 1A, 1B, 2A, 2B, and 2C, indicating their safety suitability for use in foods for infants and young children.

Foods with a history of use in a particular target population (Class 1) were presumed safe under the conditions associated with that history of use (e.g. food preparation, use levels) for infants. They were further classified as Class 1A if they raised no safety concern and required no specific precautions. They were classified as Class 1B if the documented history of use in infants was associated with particular precautions in sourcing, handling, processing, or use levels.

Foods with a history of use in the general population but not in infants (Class 2) could not be presumed safe for infants without specifically investigating any potential toxicity. Foods in this class needed to be further examined for evidence of adverse effects, and/or presence of constituents of particular toxicological concern. Results of the search allowed further classification into Classes 2A, 2B, and 2C:

Class 2A: No evidence of adverse effects, and no constituent of particular toxicological concern. No particular precautions required. Ingredients can be introduced in infant foods at similar use levels as in adult foods.

Class 2B: Evidence of adverse effects, and/or constituent(s) of particular toxicological concern, but safety can be ensured by taking particular precautions in sourcing, handling, processing (etc.), or by keeping exposure levels below the established health-based guidance values (e.g. ADI, TDI, etc.), or complying with maximum limits (e.g. MRL, etc.). Such ingredients can be introduced in infant foods, provided the appropriate precautions are taken.

Class 2C: Evidence of adverse effects, and/or constituents of particular toxicological concern, but safe levels cannot be established because the safety issue cannot be managed by taking precautions in sourcing, handling, processing (etc.), or the available data is insufficient to establish a safe level of exposure in infants.

All ingredients in classes 1A, 1B, 2A, 2B can be used in infant foods from about 4 months. Based on a precautionary approach, those ingredients in class 2C should be excluded from baby foods until after about 12 months of age.

Because of their higher food intake per kilogram body weight, infants and children may be more exposed to potential toxicants from the diet than adults. For this reason, Class 2C ingredients should be introduced in infant foods at use levels around 4 to 5 times lower than in adult foods.

The results of the analysis are shown in Table 5:

TABLE 5
Results of Analysis Performed in Example 2

| | | CLASSIFICATION |
|---|---|---|
| | | ACCORDING TO |
| FOOD INGREDIENT | SCIENTIFIC NAME | SAFETY CRITERIA |
| VEGETABLES | | |
| Artichoke | Cynara scolymus | 1A |
| Asparagus | Asparagus officinalis | 1A |
| Aubergine (Eggplant) | Solanum melongena | 1B |
| Beet | Beta vulgaris | 1A |
| Beetroot | Beta vulgaris | 1A |
| Broccoli | Brassica oleracea var. italica | 1B |
| Brussels sprout | Brassica oleracea var. | 1B |
| | gemmifera | |
| Cabbage | Brassica oleracea var. capitata | 1B |
| Carrot | Daucus carota | 1A |
| Cauliflower | Brassica oleracea var. botrytis | 1B |
| Celery | Apium graveolens var. dulce | 1A |
| Celeriac | Apium graveolens var. rapaceum | 1A |
| Cucumber | Cucumis sativus | 1A |
| Fennel | Foeniculum vulgare | 1B |
| Fennel | Foeniculum vulgare | 1B |
| French bean | Phaseolus vulgaris var. vulgaris | 1A |
| Green pea | Pisum sativum | 1B |
| Gourd | Lagenaria siceraria, Coccinia | 1B |
| | grandis | |
| Leek | Allium ampeloprasum | 1B |
| Lettuce | Lactuca sativa | 1A |
| Mushroom | Many species | 2C |
| Nettle | Urtica dioica | History of use in infants to |
| | | be documented |
| Parsnip | Pastinaca sativa | 1A |
| Potato | Solanum tuberosum | 1B |
| Pumpkin | Cucurbita maxima | 1A |
| Radish | Raphanus sativus | 1A |
| Spinach | Spinacia oleracea | 1A |
| Squash | Cucurbita spp | 1A |
| Tomato | Lycopersicon esculentum | 1B |
| Turnip | Brassica rapa | 1B |
| Watercress | Nasturtium officinale | 2C No documented history |
| | | of use in infant foods (See |
| | | Herbs & spices) |
| Zucchini | Cucurbita pepo | 1B |
| GUMS | | |
| Carob (Locust) bean gum | — | 1A |
| (E410) | | |
| Guar bean gum (E412) | — | 1A |
| Tragacanth (E413) | — | Check regulatory status |
| LEGUMES | | |
| Broad bean | Vicia faba | 1B |
| Chickpea | Cicer arietinum | 1B |
| Cowpea | Vigna unguiculata | 1B |
| Kidney bean | Phaseolus vulgaris | 1B |
| Lentil | Lens culinaris | 1B |
| Lima bean | Phaseolus lunatus | 1B |
| Mung bean | Vigna radiata | 1B |
| Pea | Pisum sativum | 1B |
| Soy | Glycine max | 1B |
| Winged bean | Psophocarpus tetragonolobus | 2B (History of use in |
| | | infants to be documented) |
| AROMATIC | | |
| VEGETABLES/SPICES | | |
| Anise | Pimpinella anisum | 1B |
| Balm mint (Lemon balm) | Melissa officinalis | 1B |
| Basil | Ocimum basilicum | 2C |
| Bay laurel | Laurus nobilis | 2C |
| Caraway | Carum carvi | 1B |
| Cardamom | Elettaria cardamomum | 2A |
| Chervil | Anthriscus cerefolium | 2C |
| Chives | Allium schoenoprasum | 2A |
| Cinnamon | Cinnamomum zeylanicum | 2C |
| Clove | Syzygium aromaticum | 2C |
| Coriander | Coriandrum sativum | 2B |
| Cumin | Cuminum cyminum | 2A |
| Curcuma | Curcuma longa | 2B |
| Garlic | Allium sativum | 2B |
| Gherkin | Cucumis sativus | 1A |
| Ginger | Zingiber officinale | 2C |
| Liquorice | Glycyrrhiza glabra | 2C |
| Mace | Myristica fragrans | 2C |
| Marjoram | Origanum majorana | 2C |
| Mint | Mentha piperata, Mentha | 2B |
| | spicata | |
| Mustard | Brassica spp | 2C |
| Nutmeg | Myristica fragrans | 2C |
| Onion | Allium cepa | 2B |
| Oregano | Origanum vulgare | 2C |
| Parsley | Petroselinum crispum | 2C |
| Pepper | Piper nigrum | 2C |
| Rosemary | Rosmarinus officinalis | 2C |
| Sage | Salvia officinalis | 2C |
| Savory | Satureja hortensis, Satureja | 2A |
| | montana | |
| Shallot | Allium cepa var. ascalonicum | 2B |
| Sorrel | Hibiscus sabdariffa | 1A |
| Tarragon | Artemisia dracunculus | 2C |
| Thyme | Thymus vulagris | 2A |
| Vanilla | Vanilla planifolia | 1A |
| FRUIT | | |
| Apple | Malus domestica | 1A |
| Apricot | Prunus armeniaca | 1A |
| Banana | Musa paradisiaca | 1A |
| Blackberry | Rubus fruticosus | 1A |
| Blackcurrant | Ribes nigrum | 1A |
| Bilberry | Vaccinium myrtillus | 1A |
| Cherry | Prunus avium, P. cerasus, | 1A |
| | P. laurocerasus, P. salicifolia | |
| Cling peach | Prunus persica | 1A |
| Date | Balanites aegyptiacus, Phoenix | 1A |
| | dactylifera | |
| Fig | Ficus carica | 1A |
| Grape | Vitis vinifera | 1A |
| Grapefruit | Citrus paradisi | 1A |
| Gooseberry | Ribes uva-crispa | 1A |
| Guava | Psidium guajava | 1A |
| Kiwi | Actinidia chinensis | 1A |
| Lemon | Citrus limon | 1A |
| Lime | Citrus limetta, C. aurantiifolia | 1A |
| Mandarin orange | Citrus reticulata | 1A |
| Mango | Mangifera indica | 1A |
| Melon | Cucumis melo | 1A |
| Nectarine | Prunus persica | 1A |
| Orange | Citrus sinensis | 1A |
| Papaya | Carica papaya | 1A |
| Passionfruit | Passiflora edulis | |
| Peach | Prunus persica | 1A |
| Pear | Pyrus communis | 1A |
| Pineapple | Ananas comosus | 1A |
| Plum | Prunus domestica | 1A |
| Quince | Cydonia oblonga | 1A |
| Raspberry | Rubus idaeus | 1A |
| Redcurrant | Ribes rubrum | 1A |
| Rhubarb | Rheum rhabarbarum | 1A |
| Strawberry | Fragaria spp | 1A |
| Tangerine | Citrus reticulata | 1A |
| Watermelon | Citrullus lanatus | 1A |
| ALMONDS/NUTS | | |
| Almond | Prunus dulcis | 2B |
| Beechnut | Fagus grandifolia | 2A |
| Brazilnut | Bertholletia excelsa | 2A |
| Cashew nut | Anacardium occidentale | 2A |
| Chestnut | Castanea sativa | 2A |
| Cocoa | Theobroma cacao | 1B |
| Coconut | Cocos nucifera | 2A |
| Hazelnut | Corylus avellana | 2A |
| Macadamia nut | Macadamia spp | 2C |
| Olive | Olea europaea | 2A |
| Peanut | Arachis hypogaea | 1A |
| Pecan nut | Carya illinoensis | 2A |
| Pistachio nut | Pistacia vera | 2A |
| Walnut | Juglans spp | 2A |
| MEAT/FISH/EGGS | | |
| Egg | — | 1A |
| Fish | — | 1A |
| Beef | — | 1A |
| Chicken | — | 1A |
| Crustaceans | — | 1A |
| Lamb | — | 1A |
| Pork | — | 1A |
| Turkey | — | 1A |

Food allergy is increasing in prevalence and is recognized as being the most common cause of allergic reactions in many different countries. Allergenic foods vary from one region to another and are strongly correlated to the eating habits of local populations. However, it is believed that the foods or food groups that are responsible for the majority of allergies around the world are gluten containing cereals, fish crustacean and mollusks, eggs and egg products, peanuts, soy, milk and dairy products, tree nuts and tree nut products, sesame seeds, mustard and celery. Of these, peanuts, sesame seeds, mustard and celery should not be given to infants before three years of age.

In the specification, there have been disclosed typical preferred embodiments of the invention and, although specific terms are employed, they are used in a generic and descriptive sense only and not for purposes of limitation, the scope of the invention being set forth in the following claims. Obviously many modifications and variations of the present invention are possible in light of the above teachings. It is therefore to be understood that within the scope of the appended claims the invention may be practiced otherwise than as specifically described.

What is claimed is:

1. A range of shelf stable baby food products wherein the content of undesirable ingredients is controlled according to a stage of infant development, wherein,
(i) baby food products for infants from about 4 to about 6 months of age (Stage 1) comprise one or more of vegetables, legumes, meat, fruits and aromatic herbs and spices; and
(ii) baby food products for infants from about 6 to about 8 months of age (Stage 2), from about 8 to about 12 months of age (Stage 3) or from about 12 to about 36 months of age (Stage Junior) comprise one or more of vegetables, legumes, meat, fish, eggs, fruits, aromatic herbs and spices and nuts.

2. A range of claim 1, wherein baby food products for infants from about 4 to about 6 months of age (Stage 1) comprise one or more vegetables selected from artichoke, carrot, cucumber, fennel, French bean, leek, lettuce, parsnip, potato, pumpkin, squash and zucchini.

3. A range of claim 1, or any preceding claim, wherein baby food products for infants from about 4 to about 6 months of age (Stage 1) comprise the legume soy.

4. A range of claim 1, or any preceding claim, wherein baby food products for infants from about 4 to about 6 months of age (Stage 1) comprise one or more meats selected from beef, veal, chicken, lamb, pork, turkey and duck.

5. A range of claim 1, or any preceding claim, wherein baby food products for infants from about 4 to about 6 months of age (Stage 1) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant and watermelon.

6. A range of claim 1, or any preceding claim, wherein baby food products for infants from about 4 to about 6 months of age (Stage 1) comprise one or more aromatic herbs and spices selected from anise, balm mint, chamomile, caraway, gherkin, orange blossom and sorrel.

7. A range of claim 1, or any preceding claim, wherein baby food products for infants from about 6 to about 8 months of age (Stage 2) comprise one or more vegetables selected from artichoke, carrot, cucumber, fennel, French bean, leek, lettuce, parsnip, potato, pumpkin, squash, zucchini, broccoli, cauliflower, eggplant (aubergine), sweet potato, tomato, pea and spinach.

8. A range of claim 1, or any preceding claim, wherein baby food products for infants from about 6 to about 8 months of age (Stage 2) comprise one or more legumes selected from soy, black gram seed, chickpea, cowpea, kidney bean, lentil, mung bean and pigeon pea.

9. A range of claim 1, or any preceding claim, wherein baby food products for infants from about 6 to about 8 months of age (Stage 2) comprise one or more meats selected from of beef, veal, chicken, lamb, pork, turkey and duck, and/or fish.

10. A range of claim 1, or any preceding claim, wherein baby food products for infants from about 6 to about 8 months of age (Stage 2) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant, watermelon, fig, papaya, passionfruit, strawberry and tangerine.

11. A range of claim 1, or any preceding claim, wherein baby food products for infants from about 6 to about 8 months of age (Stage 2) comprise one or more aromatic herbs and spices selected from anise, balm mint, chamomile, caraway, gherkin, orange blossom, sorrel, cardamom, chives, cumin, onion, saffron, savory, shallot and thyme.

12. A range of claim 1, or any preceding claim, wherein baby food products for infants from about 6 to about 8 months of age (Stage 2) comprise coconut.

13. A range of claim 1, or any preceding claim, wherein baby food products for infants from about 8 to about 12 months of age (Stage 3) comprise one or more vegetables selected from artichoke, carrot, cucumber, fennel, French bean, leek, lettuce, parsnip, potato, pumpkin, squash, zucchini, broccoli, cauliflower, eggplant (aubergine), sweet potato, tomato, pea, spinach, asparagus, beet(root), brussel sprout, cabbage, garden pea, radish and turnip.

14. A range of claim 1, or any preceding claim, wherein baby food products for infants from about 8 to about 12 months of age (Stage 3) comprise one or more legumes selected from soy, black gram seed, chickpea, cowpea, kidney bean, lentil, mung bean, pigeon pea, lima bean and winged bean.

15. A range of claim 1, or any preceding claim, wherein baby food products for infants from about 8 to about 12 months of age (Stage 3) comprise one or more meats selected from beef, veal, chicken, lamb, pork, turkey and duck, and/or fish and/or eggs.

16. A range of claim 1, or any preceding claim, wherein baby food products for infants from about 8 to about 12 months of age (Stage 3) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant, watermelon, fig, papaya, passionfruit, strawberry, tangerine and rhubarb.

17. A range of claim 1, or any preceding claim, wherein baby food products for infants from about 8 to about 12 months of age (Stage 3) comprise one or more aromatic herbs and spices selected from anise, balm mint, chamomile, caraway, gherkin, orange blossom, sorrel, cardamom, chives, cumin, onion, saffron, savory, shallot, thyme, coriander, curcuma, garden sorrel, garlic, mint and vanilla.

18. A range of claim 1, or any preceding claim, wherein baby food products for infants from about 8 to about 12 months of age (Stage 3) comprise coconut and/or cocoa.

19. A range of claim 1, or any preceding claim, wherein baby food products for infants from about 12 to about 36 months of age (Stage Junior) comprise one or more vegetables selected from artichoke, carrot, cucumber, fennel, French bean, leek, lettuce, parsnip, potato, pumpkin, squash, zucchini, broccoli, cauliflower, eggplant (aubergine), sweet potato, tomato, pea, spinach, asparagus, beet(root), brussel sprout, cabbage, garden pea, radish, turnip, mushroom and watercress.

20. A range of claim 1, or any preceding claim, wherein baby food products for infants from about 12 to about 36 months of age (Stage Junior) comprise one or more legumes selected from soy, black gram seed, chickpea, cowpea, kidney bean, lentil, mung bean, pigeon pea, lima bean and winged bean.

21. A range of claim 1, or any preceding claim, wherein baby food products for infants from about 12 to about 36 months of age (Stage Junior) comprise one or more meats selected from beef, veal, chicken, lamb, pork, turkey, duck, and/or fish, and/or eggs and/or crustaceans.

22. A range of claim 1, or any preceding claim, wherein baby food products for infants from about 12 to about 36 months of age (Stage Junior) comprise one or more fruits selected from apple, apricot, banana, blackberry, blackcurrant, bilberry, cherry, date, grape, gooseberry, guava, lemon, lime, mandarin, mango, melon, nectarine, olive, orange, peach, pear, pineapple, plum, quince, raspberry, redcurrant, watermelon, fig, papaya, passionfruit, strawberry, tangerine, rhubarb, grapefruit and kiwi.

23. A range of claim 1, or any preceding claim, wherein baby food products for infants from about 12 to about 36 months of age (Stage Junior) comprise one or more aromatic herbs and spices selected from anise, balm mint, chamomile, caraway, gherkin, orange blossom, sorrel, cardamom, chives, cumin, onion, saffron, savory, shallot, thyme, coriander, curcuma, garden sorrel, garlic, mint, vanilla, basil, bay laurel, chervil, cinnamon, clove, ginger, liquorice, mace, marjoram, nutmeg, oregano, parsley, pepper, rosemary, sage and terragon.

24. A range of claim 1, or any preceding claim, wherein baby food products for infants from about 12 to about 36 months of age (Stage Junior) comprise one or more nuts selected from coconut, cocoa, almond, beechnut, brazil nut, cashew nut, chestnut, hazelnut, macadamia nut, pecan nut, pistachio nut and walnut.

25. A range of claim 1 or any preceding claim, wherein the baby food products do not contain peanuts, sesame seeds, mustard or celery.

26. A method for assessing the safety of a baby food product ingredient, the method comprising:
(i) assessing the safety of intrinsic constituents in the ingredient;
(ii) assessing the presence of anti-nutritional factors in the ingredient;
(iii) assessing the potential of the ingredient to cause an allergic reaction; and
(iv) combining the results from steps (i) to (iii) and assigning the ingredient to one or more safety categories.

27. A method according to claim 26, wherein the safety categories are selected from Group 1, Group 2, Group 3 and Group Junior, wherein
(a) ingredients assigned to Group 1 are safe for inclusion in a baby food product for infants from about 4 to about 6 months of age;
(b) ingredients assigned to Group 2 are safe for inclusion in a baby food product for infants from about 6 to about 8 months of age;
(c) ingredients assigned to Group 3 are safe for inclusion in a baby food product for infants from about 8 to about 12 months of age; and
(d) ingredients assigned to Group Junior are safe for inclusion in a baby food product for infants from about 12 to about 36 months of age.

28. A method according to claim 26, or claim 26 or 27, wherein the safety categories are selected from 1A, 1B, 2A, 2B and 2C, wherein,
(a) ingredients assigned to 1A have a safe history of use in a particular infant population, raise no safety concern and require no specific precautions;
(b) ingredients assigned to 1B have a safe history of use in a particular infant population but are associated with particular precautions in sourcing, handling, processing or use levels;
(c) ingredients assigned to 2A have no evidence of adverse effects, no constituent of particular toxicological concern and require no particular precautions;
(d) ingredients assigned to 2B have evidence of adverse effects and/or constituents of particular toxicological concern but safety can be ensured by,
(i) taking particular precautions in sourcing, handling, processing or use levels;
(ii) keeping exposure levels below established health-based guidance values; or
(iii) complying with maximum limits; and
(e) ingredients assigned to 2C have evidence of adverse effects and/or constituents of particular toxilogical concern and safe levels cannot be established by,
(i) taking particular precautions in sourcing, handling, processing or use levels;
(ii) keeping exposure levels below established health-based guidance values; or
(iii) complying with maximum limits

29. A method of 28, wherein ingredients assigned to 1A, 1B, 2A and 2B are safe for inclusion in a baby food product for infants from about 4 months of age, and ingredients assigned to 2C are safe for inclusion in a baby food product for infants from about 12 months of age.

30. A method of claim 29, wherein ingredients assigned to 2C are safe for inclusion in a baby food product for infants from about 12 months of age when present at use levels about 4 to about 5 times lower than use levels in adult food products.
